(19) United States
(12) Patent Application Publication
(10) Pub. No.: US 2026/0198401 A1
(43) Pub. Date: Jul. 16, 2026

(54) FOLDABLE HARVEST ATTACHMENT WITH SWIVEL ARMS

(71) Applicant: Maschinenfabrik Bernard Krone GmbH & Co. KG, Spelle (DE)

(72) Inventors: MARTIN BOLSMANN, Andervenne (DE); TOBIAS OSKAMP, Ochtrup (DE); FRANK AHLMER, Westerkappeln (DE); MARKUS ESTER, Beesten (DE); Steven Büchter, Recke (DE); Hannes Mählmann-Dunker, Neuenkirchen (DE)

(21) Appl. No.: 19/353,830

(22) Filed: Oct. 9, 2025

(30) Foreign Application Priority Data
Oct. 9, 2024 (DE) 102024129137.0

(51) Int. Cl. A01B 73/04; A01D 43/08; A01D 61/00

(52) U.S. Cl. CPC A01B 73/044; A01D 43/086; A01D 61/002

(57) ABSTRACT

The invention relates to a harvesting attachment (10) for harvesting field crops. The harvesting attachment (10) comprises a frame device (12) designed to be coupled to a harvesting vehicle (80) and at least three attachment segments (1, 2, 3, 4) designed to receive the crops, which, in a working position (I) of the harvesting attachment (10), adjoin each other in a first position (a) in a transverse direction (QR) perpendicular to a direction of travel (FR). The harvesting attachment (10) also comprises a transfer device (20) which is designed to transfer the harvesting attachment (10) from the working position (I) into a transport position (VI), in which at least a first of the attachment segments (1) is arranged in a second position (b), in which it is arranged pivoted by more than 45° relative to the frame device (12) relative to its first position (i). According to the invention, at least the first attachment segment (1) is movably mounted on at least one first transfer element (5) which is movably arranged on the frame device (12).

The invention relates to a harvesting attachment for harvesting field crops. The harvesting attachment comprises a frame device designed for coupling to a harvesting vehicle. The harvesting attachment comprises at least four attachment segments designed to receive the crops. These are in particular a first, a second, a third and a fourth attachment segment. In a working position of the harvesting attachment, the attachment segments are each in a first position and are connected to one another in a transverse direction at right angles to a direction of travel. The harvesting attachment comprises a transfer device which is designed to transfer the harvesting attachment from the working position into a transport position. In the transport position, at least a first of the attachment segments is arranged in a second position in which it is pivoted by more than 45° relative to the frame device, starting from its first position.

Such a harvesting attachment is known from EP 3 311 646A1 . The well-known harvesting attachment is a row-dependent corn attachment for coupling to a combine harvester. The row-dependent corn attachment comprises four attachment segments and must be moved into the transport position so that it can be transported in the coupled state over public roads. The middle two of the attachment segments are pivotably mounted to each other by means of a pivot bearing. The disadvantages of the known harvesting attachment are, on the one hand, the necessary complex bearings, for example the partially transversely movable bearing of the two outer attachment segments and the partially upwardly movable bearing of the aforementioned pivot bearing, which are cost-intensive and mean a high risk of failure. In addition, the working width of the harvesting attachment is strictly limited by the fact that the attachment segments are complex and mounted directly on each other or on the frame device. The pivot bearing hinders the formation of the middle attachment segments to achieve an optimal harvest of the crops.

The object of the present invention is to provide a generic harvesting attachment which is particularly reliable and enables the largest possible working width. Furthermore, the object of the invention is to provide a harvesting system comprising the harvesting attachment.

For this purpose, a harvesting attachment for harvesting field crops is created, comprising a frame device designed to be coupled to a harvesting vehicle, at least four attachment segments designed to receive the field crops, which in a working position of the harvesting attachment each adjoin one another in a first position in a transverse direction perpendicular to a direction of travel, and a transfer device designed to transfer the harvesting attachment from the working position into a transport position, in which at least a first of the attachment segments is arranged in a second position in which it is arranged pivoted by more than 45° relative to the frame device, starting from its first position.

According to the invention, at least the first attachment segment is movably mounted on at least one first transfer element. The first transfer element is movably mounted on the frame device. The first transfer element is in particular comprised by the transfer device. The first transfer element is preferably designed as a rigid, load-bearing and in particular elongated structural element, particularly preferably designed as a control arm. The first transfer element is not one of the attachment segments. The first transfer element is designed to hold and transfer the first attachment segment, but not to pick up the crops itself. The use of the first transfer element between the first attachment segment and the frame device significantly increases the range of movement of the first attachment segment for transferring the harvesting attachment from the working position to the transport position, which is why the first transfer element enables significantly larger working widths of the harvesting attachment without restricting the possibility of transport on public roads.

Preferably, the first attachment segment is pivotably mounted on the first transfer element about a transfer segment pivot axis. Alternatively or additionally, the first transfer element is pivotably mounted on the frame device about a transfer frame pivot axis. In particular, the first transfer element is movable relative to the frame device and/or relative to the first attachment segment exclusively in a pivotable manner about the respective axis. This makes the harvesting attachment particularly simple and fail-safe. For a particularly practical transfer path of the first attachment segment, the transfer frame pivot axis is further spaced from a support plane than the transfer segment pivot axis, at least in the working position of the harvesting attachment, and in particular also in the transport position of the harvesting attachment in the region of the first transfer element. The support plane ideally represents the surface of a soil on which the harvesting attachment is operated. In particular, the harvesting attachment and/or the harvesting vehicle touches the support plane during operation, preferably with a carriage.

The frame device is designed in particular for coupling to a forage harvester, a combine harvester or similar harvesting vehicle. Preferably, the harvesting attachment has a particularly preferably central catchment region from which the crops are to be at least partially collected by the harvesting vehicle at least partially against the direction of travel. The harvesting vehicle is designed in particular to process at least part of the crops. The attachment segments are preferably each designed to convey at least a portion of the crops into the catchment region, depending on the attachment segment at least partially in or against the transverse direction.

The harvesting attachment according to the invention must be distinguished from devices or working machines that are to be attached to standard tractors by means of three-point hitches. The arrangement of the harvesting attachment according to the invention on standard tractors in order to be operated by them is not possible, in particular due to the catchment region, which is at least not compatible with the receptacles of standard tractors without further measures.

The attachment segments are designed to receive the crops in such a way that at least a part of the crop is received at least temporarily insofar as a force of the attachment segment acts at least temporarily on the part and/or a weight force of the part is at least temporarily absorbed by the attachment segment. Preferably, each attachment segment has at least one cutting element rotating during operation for cutting the crops and/or at least one conveying element rotating during operation for conveying the crops in a segment conveying direction, in particular in the direction of the catchment region. The conveying element and/or the cutting element are/is designed in particular as a cutting chain or conveying chain, which during operation rotate/rotates around two spaced-apart deflection elements of the respective attachment segment, or alternatively as cutting discs or conveying drums, which each rotate about a respective rotational axis during operation. During operation, the crops are preferably transferred from the conveying element of one of the conveying segments to the conveying element of an adjacent one of the attachment segments. Due to the design described above, the harvesting attachment is particularly suitable for harvesting maize and cereals and can develop its described advantageous effects for this purpose. Crops do not necessarily mean exclusively fruits in the botanical sense, but include in particular other or even all parts of the plant bearing the fruit.

The transfer device enables a working width of the harvesting attachment that exceeds the maximum width permitted for road traffic without preventing the transport of the harvesting attachment on public roads. In the transport position, the harvesting attachment has a transport width that is smaller than the working width. To transfer the harvesting attachment from the working position to the transport position, all attachment segments are preferably moved relative to the frame device.

To transfer the harvesting attachment from the working position to the transport position, at least the first attachment segment is pivoted relative to the frame device from its first position to its second position by more than 45°. In a front view, the first attachment segment and/or its conveying element and/or a conveying direction which is fixed to the attachment segment and in which the attachment segment is designed for conveying, is preferably pivoted at least substantially by 90°. By pivoting, the first attachment segment is transferred from a mainly flat arrangement in the working position of the harvesting attachment to a mainly upright arrangement in the transport position of the harvesting attachment.

The harvesting attachment preferably has an even number of attachment segments. Preferably, the harvesting attachment is designed to be mirror-symmetrical with respect to a longitudinal center plane, at least with respect to the attachment segments, particularly preferably with respect to its entire basic structure and in particular only apart from drive and auxiliary units and auxiliary and input means. The longitudinal center plane extends at right angles to the support plane and in the direction of travel, i.e. at right angles to the transverse direction, and preferably intersects the catchment region. The longitudinal center plane preferably does not intersect any of the attachment segments, at least in one position of the harvesting attachment. The harvesting attachment preferably has exactly four attachment segments.

The transfer device is preferably designed such that, when the harvesting attachment is transferred from the working position into the transport position, each of the at least four attachment segments, as described above in particular with regard to the first attachment segment, is pivoted by more than 45° from its respective first position into its respective second position relative to the frame device. Adjacent attachment segments preferably have different pivoting directions relative to the frame device. The middle two attachment segments, in particular the first and the third attachment segment, are particularly preferably pivoted from their first position into their second position in such a way that an end facing the longitudinal center plane in the working position of the harvesting attachment and thus in the first position of these two attachment segments is arranged facing away from the support plane in the transport position of the harvesting attachment and thus in the second position of these attachment segments. The transfer element enables, in particular, that the harvesting attachment is free from a pivot bearing which connects the two middle attachment segments so that they can pivot about a pivot axis lying in the longitudinal center plane. This allows for a better flow of crops into the catchment region. The third attachment segment is preferably movably mounted on at least one second transfer element, which is movable and mounted in particular mirror-symmetrical relative to the first transfer element. The arrangement of the third attachment segment on the second transfer element is preferably provided in an analogous manner to the arrangement of the first attachment segment on the first transfer element.

The first attachment segment is arranged between the second attachment segment and the third attachment segment, at least in the working position of the harvesting attachment. Alternatively, it is also conceivable that the first attachment segment is an outer one of the attachment segments, at least in the working position of the harvesting attachment. In this case, the first attachment segment is arranged at a distance from the catchment region in or against the transverse direction. The second attachment segment is preferably pivotably mounted on the first attachment segment about an intermediate segment pivot axis. The second attachment segment is particularly preferably connected to the frame device exclusively by means of the first attachment segment and the first transfer element, wherein the first attachment segment is preferably arranged between the second attachment segment and the longitudinal center plane in the working position of the harvesting attachment.

Due to the particularly mirror-symmetrical arrangement of the first and second attachment segments on the one hand and the third and fourth attachment segments on the other hand, what is described for the transfer of the first and second attachment segments preferably applies in the following analogously, with opposite direction(s), to the third and fourth attachment segments. The transfer device is preferably designed such that the distance to be measured in the transverse direction between the first attachment segment and the third attachment segment varies during the transfer of the harvesting attachment from the working position to the transport position. Preferably, the two middle attachment segments are temporarily spaced further apart from each other than in the working position of the harvesting attachment in order to create space for their respective pivoting.

Preferably, the transfer device is designed such that at least one of the attachment segments, particularly preferably the second attachment segment, is arranged at least partially or predominantly in front of the first transfer element in the direction of travel, at least in the transport position of the harvesting attachment. This means that this attachment segment at least partially covers the first transfer element in a front view of the harvesting attachment. In particular, the first attachment segment at least partially conceals the first transfer element in the front view, at least when the harvesting attachment is arranged in the working position. Particularly preferably, the second attachment segment is spaced apart from the first transfer element in the transverse direction in the working position of the harvesting attachment.

Preferably, the transfer device has a first actuator for pivoting the second attachment segment relative to the first attachment segment. The first actuator is preferably arranged in front of the first transfer element in the direction of travel, at least in the working position of the harvesting attachment. The first actuator at least partially covers the first transfer element in the working position of the harvesting attachment, i.e. in the front view. An end of the first actuator facing the longitudinal center plane is preferably arranged on an inner half of the first attachment segment. In this way, reliable pivoting around the intermediate segment pivot axis with advantageous weight distribution is ensured.

Preferably, the transfer device comprises a transfer arrangement for pivoting the first attachment segment relative to the first transfer element. The transfer arrangement particularly preferably comprises a second actuator. The second actuator is arranged in particular on the frame device. The transfer arrangement comprises in particular a transmission element which is mounted pivotably about a transmission element pivot axis relative to the first transfer element and/or relative to the frame device. The transmission element pivot axis is particularly preferably arranged coaxially to the transmission frame pivot axis. In particular, the second actuator is arranged on the transmission element. The transfer arrangement preferably comprises a control arm element which is arranged at one end on the transmission element and at the other end on the first attachment segment.

The control arm element is particularly preferably arranged on the first attachment segment near the end of the first actuator facing the longitudinal center plane. In particular, the control arm element is arranged closer to the longitudinal center plane than the first transfer element, at least in the working position of the harvesting attachment. The transmission element is particularly preferably designed for transmission in such a way that a bearing point of the second actuator on the transmission element has a smaller distance from the transmission element pivot axis than a bearing point of the control arm element on the transmission element. The design of the transfer arrangement described above allows the intended transfer to be achieved even with large working widths and thus large distances to be covered by the attachment segments to transfer the harvesting attachment from the working position to the transport position. The transmission element and the control arm element also reduce the installation space requirement of the transfer device immediately adjacent to the attachment segments to a minimum.

The transfer device preferably has a third actuator for pivoting the first transfer element relative to the frame device. The third actuator is preferably arranged on an actuator leg of the first transfer element. This actuator leg extends from the transfer frame pivot axis, at least in the working position of the harvesting attachment, away from the first attachment segment, i.e. in particular away from the support plane, preferably upwards. The first transfer element is preferably designed as a single piece and is rigid. By arranging the third actuator on the actuator leg, competing space requirements of different components of the transfer device are avoided and a structurally simple design of the transfer device is ensured.

Preferably, the second actuator, the third actuator and/or the transmission element are/is arranged above the first attachment segment, at least in the working position of the harvesting attachment, at least in the front view. This means that in the front view, the first attachment segment is arranged between the second actuator, the third actuator and/or the transmission element and the support plane. In particular, the first actuator, the second actuator and/or the third actuator is/are arranged, at least in the working position of the harvesting attachment, in such a way that their direction(s) of movement are/are angled by less than 45°, in particular by less than 22.5°, relative to the support plane. The design described above ensures optimal use of the available installation space and enables a structure that ensures high reliability.

Preferably, the first transfer element is designed such that a section of the first transfer element surrounding the transfer frame pivot axis is arranged on the one hand, i.e. on one side, of an auxiliary plane and a section of the first transfer element surrounding the transfer segment pivot axis is arranged on the other hand, i.e. on another side, opposite the one side, of the auxiliary plane. The auxiliary plane is oriented at right angles relative to the transfer frame pivot axis and/or the transfer segment pivot axis. Optimally, the first transfer element is S-shaped in such a way that the S-shape is visible in a side view at least in one position of the harvesting attachment. This design of the first transfer element ensures that the harvesting attachment can be transferred from the working position to the transport position even with large working widths, without the risk of collisions between different components of the harvesting attachment.

The transfer segment pivot axis, the transfer frame pivot axis, the intermediate segment pivot axis and/or the transmission element pivot axis are/is aligned at least substantially parallel to the direction of travel. This means that said axis(es) are angled by less than 22.5° relative to the support plane, at least in one position of the harvesting attachment, at least in a side view. The axes mentioned, which are in particular approximately parallel, facilitate the reliable assembly of the harvesting attachment and enable large working widths, in particular because the center of gravity of the harvesting attachment is kept as far back as possible relative to the direction of travel during transfer and in the transport position.

The harvesting attachment comprises at least one, in particular multiple, locking devices for fixing components of the harvesting attachment relative to one another in the working position and/or in the transport position of the harvesting attachment. Preferably, the harvesting attachment has a frame segment locking device for fixing at least the first attachment segment to the frame device and/or to the third attachment segment. The frame segment locking device particularly preferably comprises on the first attachment segment a pin which is movable in the transverse direction, in particular in the working position, and a recess formed by the frame device and/or by the third attachment segment, into which the pin can engage for locking. Fixing means an immovable fixing which at least prevents an unintentional translational movement and/or pivoting movement of the first attachment segment.

The harvesting attachment preferably has a segment locking device for fixing the first attachment segment relative to the second attachment segment at least in the working position of the harvesting attachment. Alternatively or additionally, the harvesting attachment has a transfer segment locking device for fixing at least the second attachment segment to the first transfer element. The transfer segment locking device serves in particular for fixing the harvesting attachment in the transport position and/or comprises a hook arranged on the first transfer element into which a bolt arranged on the second attachment segment engages. Preferably, the harvesting attachment comprises a frame transfer locking device for fixing at least the first transfer element to the frame device. The frame transfer locking device is used to fix it in the transport position. The described locking devices increase the reliability of the harvesting attachment, in particular by reliably preventing unintentional loads on the components of the harvesting attachment.

Starting from the preamble of claim 1 and not necessarily, but preferably, building on the features of the characterizing part of claim 1, the harvesting attachment preferably has a support wheel device. The support wheel device comprises at least a first support wheel and in particular a second support wheel arranged mirror-symmetrically with respect to the longitudinal center plane. The first support wheel is preferably arranged on one of the attachment segments, in particular on the second attachment segment. The support wheel device preferably comprises a bearing arrangement by means of which the first support wheel is mounted on the attachment segment. The bearing arrangement is particularly preferably designed to transfer the first support wheel relative to the attachment segment from a passive position, in which the attachment segment projects beyond the support wheel in its segment conveying direction, into an active position, in which the first support wheel projects beyond the attachment segment in the segment conveying direction of the attachment segment.

The support wheel device preferably comprises a support wheel sensor for detecting an arrangement of the first support wheel at least in the passive position. The support wheel device comprises in particular a support wheel actuator which is designed to transfer the first support wheel from the passive position into the active position and is designed to change its length measured in a wheel actuator direction. Preferably, the support wheel device has a control device designed to control the support, which comprises a pressure sensor for measuring a pressure present in the support wheel actuator and at least one valve for increasing and/or reducing the pressure and is designed to automatically control the valve depending on the measured pressure.

The bearing arrangement preferably has at least one wheel control arm element which is pivotably mounted about a control arm pivot axis on the attachment segment and on which the first support wheel is rotatably mounted about a wheel rotation axis. The wheel control arm element particularly preferably comprises a first wheel control arm leg and a second wheel control arm leg, wherein the first support wheel is arranged at least partially between the first wheel control arm leg and the second wheel control arm leg and is mounted on the first wheel control arm leg and the second wheel control arm leg so as to be rotatable about the wheel rotation axis. The bearing arrangement has a transmission element between the support wheel actuator and the wheel control arm element, which is mounted pivotably relative to the support wheel actuator about a transmission pivot axis angled to the wheel actuator direction, which is in particular oriented non-parallel relative to the wheel rotation axis in order to relieve the bearing arrangement when cornering.

The object is further achieved by a harvesting system. The harvesting system comprises a harvesting vehicle with a carriage that includes multiple driving elements, e.g. wheels, adjacent to the support plane. The harvesting system also comprises a previously described harvesting attachment which is coupled to the harvesting vehicle by means of the frame device. The coupling is designed in particular in such a way that the harvesting vehicle drives the harvesting attachment during operation. The harvesting vehicle is a self-propelled, i.e. self-motorized, vehicle designed for the purpose of harvesting crops. A tractor is preferably not a previously described harvesting vehicle.

The harvesting vehicle preferably has a catchment device which, during operation, feeds in the crops, particularly from the catchment region of the harvesting attachment, at least partially against the direction of travel. In particular, the harvesting vehicle is a combine harvester or a forage harvester. If the harvesting vehicle is designed as a forage harvester, the catchment device is preferably connected to a chopping unit of the forage harvester and a discharge chute of the forage harvester.

The harvesting vehicle preferably comprises an attachment device control device for controlling the harvesting attachment, which is designed to receive a signal from the support wheel sensor and has at least one function for moving at least one of the attachment segments such that the movement requires the reception of a signal from the support wheel sensor signaling the arrangement of the first support wheel in the passive position. The attachment device control device is designed in particular to control the harvesting attachment in such a way that the valve is controlled as a function of a driving speed determined by a driving speed sensor of the harvesting vehicle. Particularly preferably, the first support wheel is relieved of load by means of the support wheel actuator from a predetermined driving speed, the support wheel actuator in particular being brought into a floating position. This makes it possible to reduce the wear on the support wheel when cornering slowly and taking tight turns, particularly when the first support wheel cannot be steered.

Further details and advantages of the invention can be seen from the schematically illustrated figures described below; in particular:

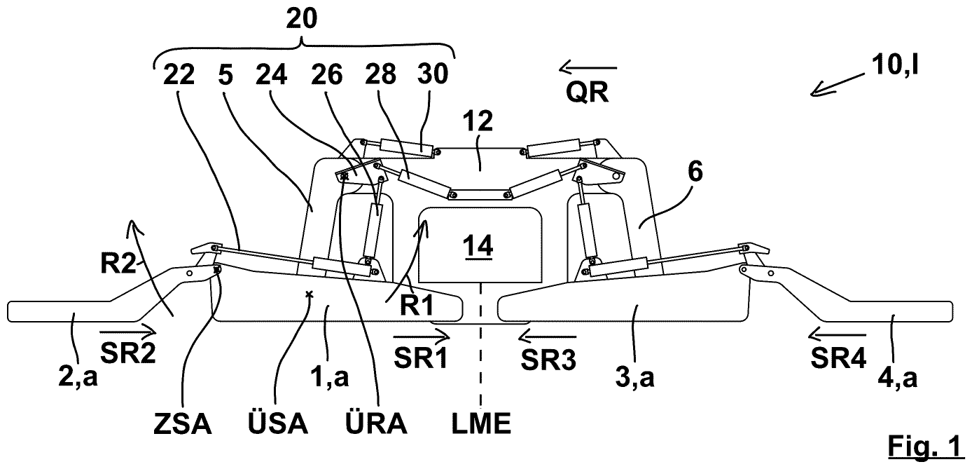

FIG. 1 shows a front view of a simplified representation of a first harvesting attachment according to the invention in a working position,

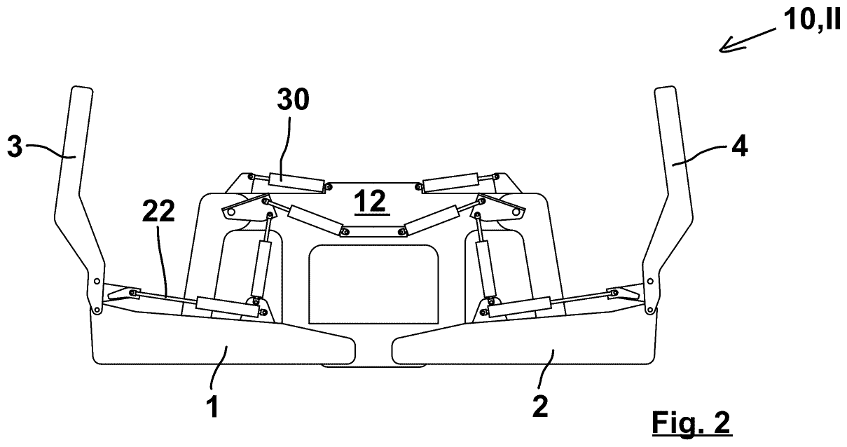

FIG. 2 shows a front view of the first harvesting attachment in a first intermediate position,

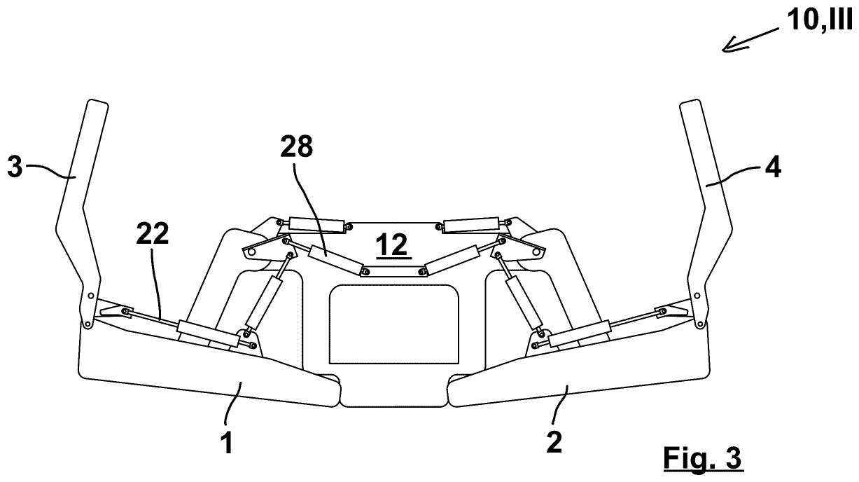

FIG. 3 shows a front view of the first harvesting attachment in a second intermediate position,

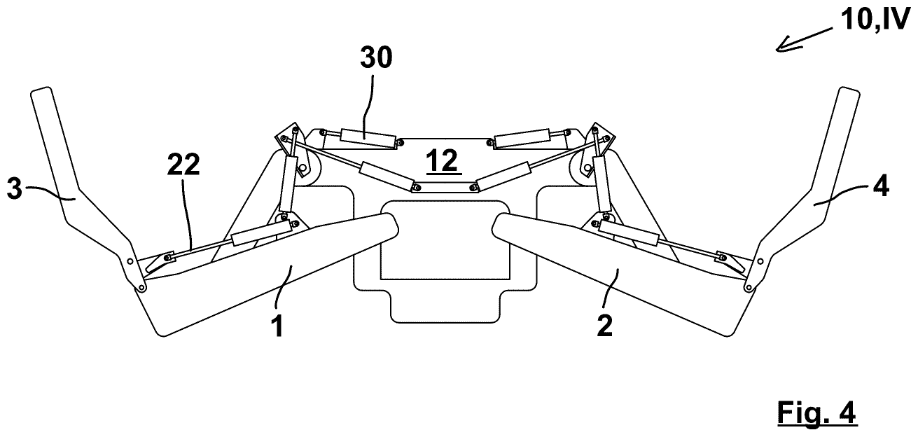

FIG. 4 shows a front view of the first harvesting attachment in a third intermediate position,

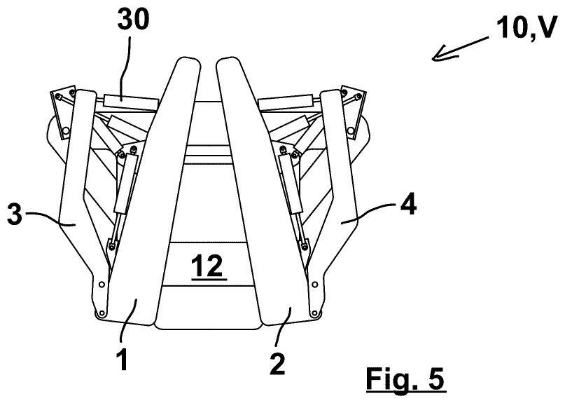

FIG. 5 shows a front view of the first harvesting attachment in a fourth intermediate position,

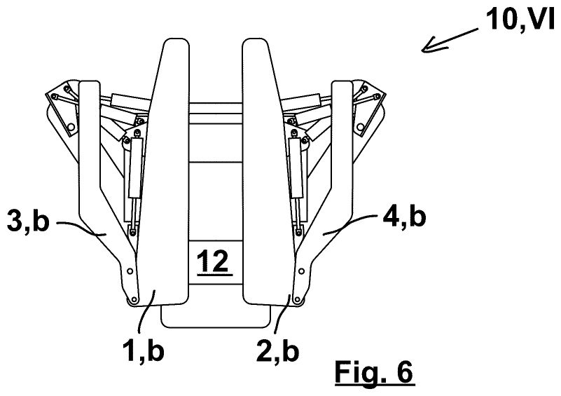

FIG. 6 shows a front view of the first harvesting attachment in a transport position,

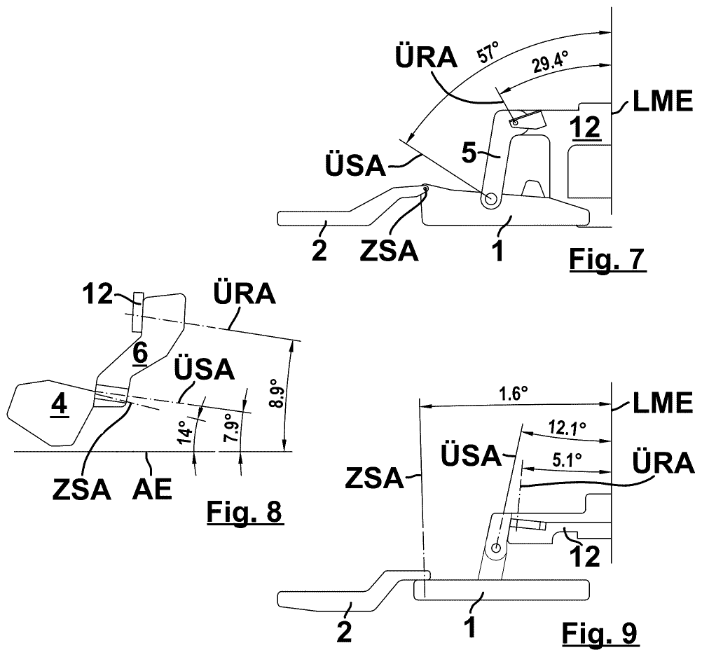

FIG. 7 shows a further simplified front view of the first harvesting attachment in the working position,

FIG. 8 shows a side view of the first harvesting attachment according to FIG. 7,

FIG. 9 shows a plan view of the first harvesting attachment according to FIG. 7,

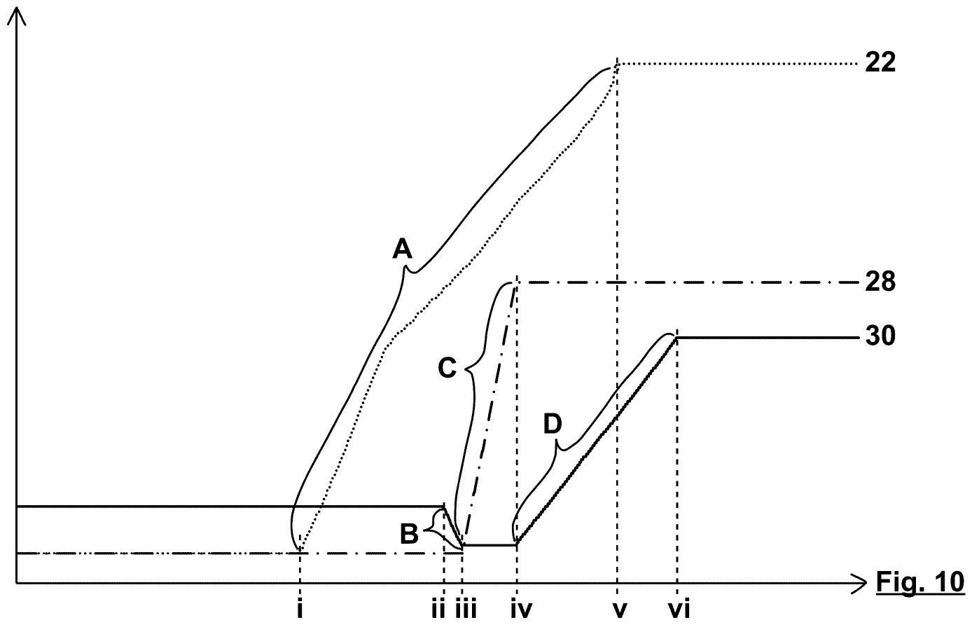

FIG. 10 shows a pivoting angle-time diagram,

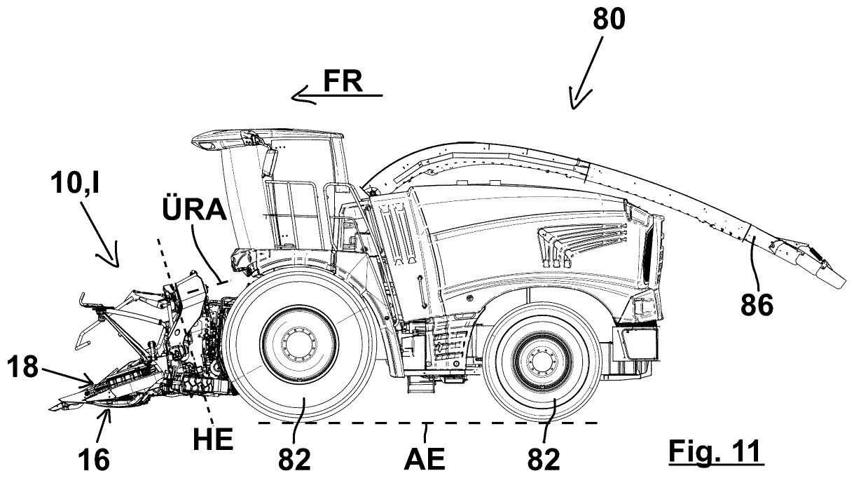

FIG. 11 shows a side view of a forage harvester with a second harvesting attachment according to the invention in the working position,

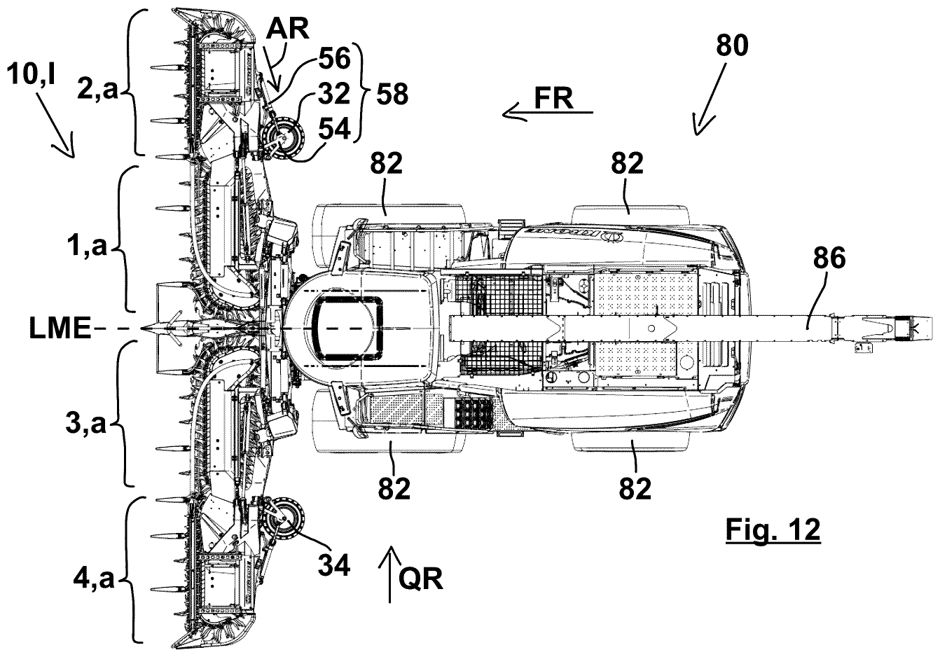

FIG. 12 shows a plan view of the forage harvester with the second harvesting attachment according to FIG. 11,

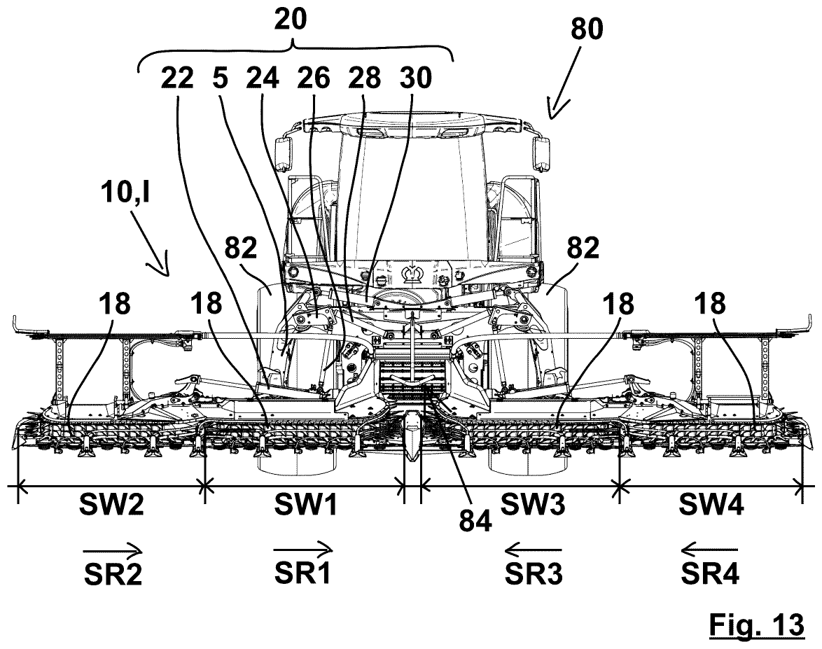

FIG. 13 shows a front view of the forage harvester and the second harvesting attachment according to FIG. 11,

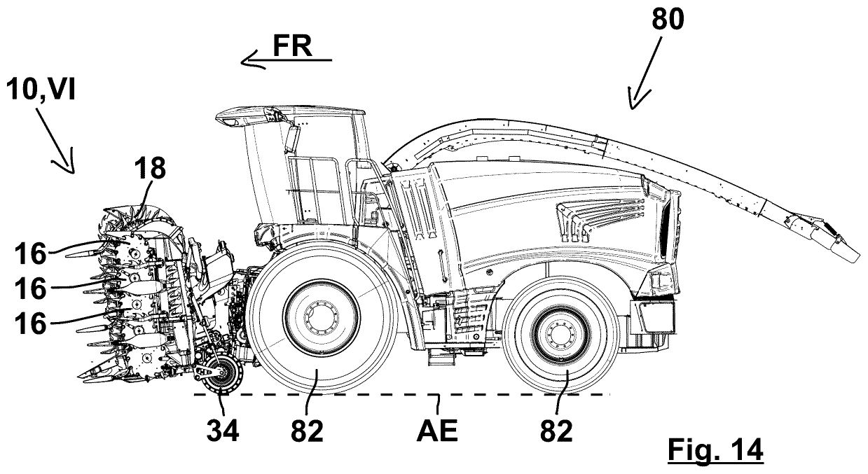

FIG. 14 shows a side view of the forage harvester and the second harvesting attachment in a transport position,

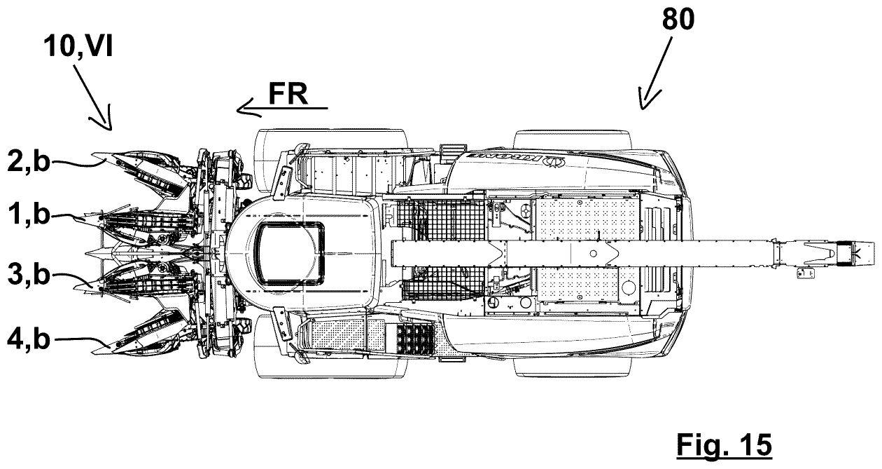

FIG. 15 shows a plan view of the forage harvester and the second harvesting attachment according to FIG. 14,

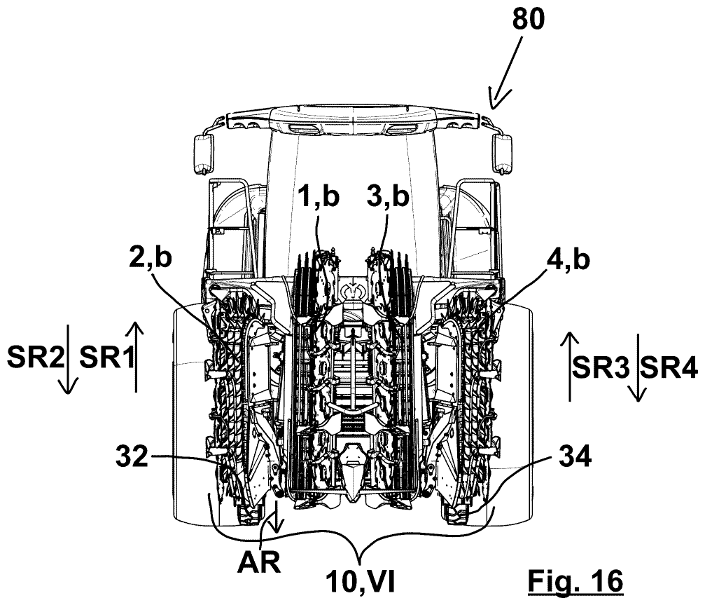

FIG. 16 shows a front view of the forage harvester and the second harvesting attachment according to FIG. 14,

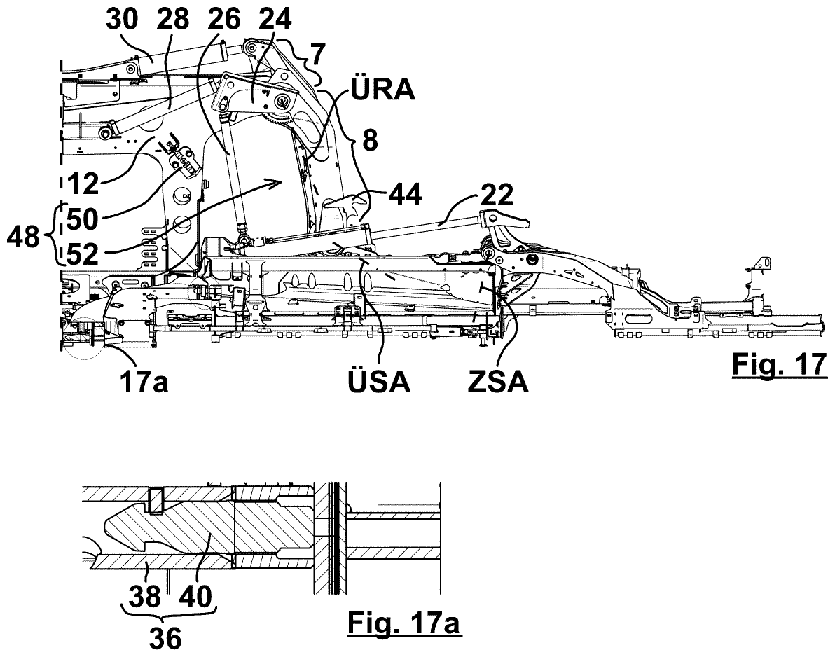

FIG. 17 shows a front view of the partially shown second harvesting attachment according to FIG. 11,

FIG. 17a shows an enlarged view of a detail of FIG. 17,

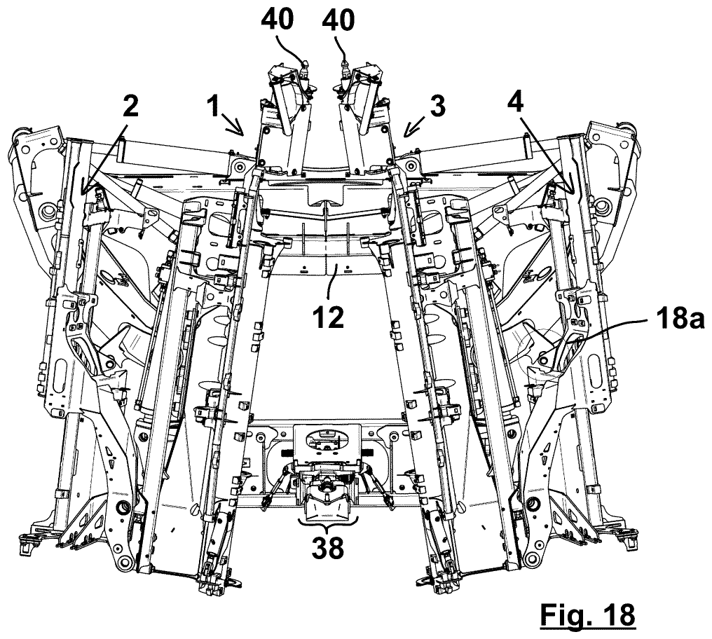

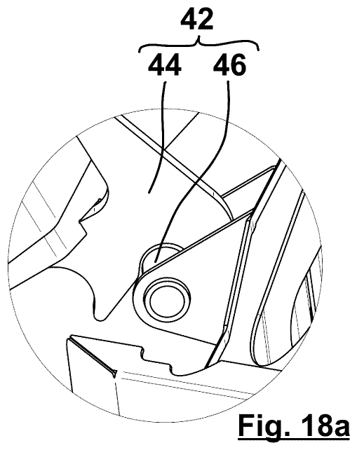

FIG. 18 shows a front view of the partially shown second harvesting attachment in the fourth intermediate position,

FIG. 18a shows an enlarged view of a detail of FIG. 18.

Parts of the exemplary embodiments according to the invention that have an identical or similar effect or design are selectively provided with the same reference numerals in the figures. Features described in relation to one of these parts shall be understood as being described in relation to all of these parts. Features described with reference to one of two mirror-symmetrically arranged parts are to be understood as being described with reference to the other of the parts. Further developments according to the invention also result from other combinations of the described features than those shown.

The figures show different harvesting attachments 10 according to the invention, each of which is designed for row-independent harvesting of maize. The harvesting attachments 10 each comprise a frame device 12 which is provided for coupling the respective harvesting attachment 10 to a harvesting vehicle designed as a forage harvester 80. FIGS. 11 to 18a show a second harvesting attachment 10 according to the invention coupled to the forage harvester 80.

The forage harvester 80 and the harvesting attachment 10 together form a harvesting system designed as a forage harvester system. The forage harvester 80 has a carriage with four driving elements 82, each of which is adjacent to a support plane AE. The forage harvester 80 (see FIG. 11 ff.) further comprises a catchment device 84 which, viewed in the direction of travel FR, extends between the front driving elements 82 and subsequently to a catchment region 14 of the harvesting attachment 10. In the direction of crop flow, the catchment device 84 is followed by a chopping unit (not shown) and a discharge chute 86 of the forage harvester 80, which is shown in simplified form in FIG. 11 ff. in a chute transport position. During operation, the forage harvester 80 with the harvesting attachment 10 moves in the direction of travel FR.

Both the first exemplary embodiment of the harvesting attachment 10 and the second exemplary embodiment of the harvesting attachment 10 each have four attachment segments 1, 2, 3, 4. Each of the attachment segments 1, 2, 3, 4 has a plurality of cutting elements 16 which rotate during operation for cutting maize plants. In addition, each of the attachment segments 1, 2, 3, 4 has exactly one conveying element 18 which circulates as a conveying chain during operation for conveying the maize plants in a segment conveying direction SR1, SR2, SR3, SR4 (see FIGS. 11 and 14). The first exemplary embodiment of the harvesting attachment 10 is shown in FIGS. 1 to 9 in such a simplified manner that the cutting elements 16 and the conveying elements 18 are not shown.

Both exemplary embodiments of the harvesting attachment 10 have a transfer device 20 for transferring the respective harvesting attachment 10 from a working position I (FIG. 1, 11 to 13) into a transport position VI (FIG. 6, 14 to 16). In the working position, the attachment segments 1, 2, 3, 4 adjoin each other in a transverse direction QR, which is oriented at right angles to the direction of travel FR and parallel to the support plane AE. In the working position I, the attachment segments 1, 2, 3, 4 adjoin each other in such a way that their segment conveying directions SR1, SR2, SR3, SR4 are parallel to the transverse direction QR and aligned with the catchment region 14. The attachment segments 1, 2, 3, 4 are arranged in a first position a in the working position I of the attachment 10. The catchment region 14 is intersected by a longitudinal center plane LME perpendicular to the transverse direction QR, to which the harvesting attachment 10 is formed essentially mirror-symmetrical. The segment conveying directions SR1 and SR2 are therefore opposite to the segment conveying directions SR3 and SR4. In working position I, the first conveying segment 1 and the second conveying segment 2 extend into the catchment region 14.

In the transport position VI, the attachment segments 1, 2, 3, 4 are arranged such that their segment conveying directions SR1, SR2, SR3 and SR4 are all aligned at least substantially parallel to the longitudinal center plane LME. In the transport position VI of the harvesting attachment 10, the attachment segments 1, 2, 3, 4 are arranged in a second position b, in which they are pivoted by approximately 90° relative to the frame device 12, starting from their first position a. In the transport position VI, the first segment conveying direction SR1 of the first attachment segment 1 and the third segment conveying direction SR3 of the third attachment segment 3 are directed away from the support plane AE, whereas the second segment conveying direction SR2 of the second attachment segment 2 and the fourth segment conveying direction SR 4 of the fourth attachment segment 4 are directed towards the support plane AE (FIG. 16). In addition, in the transport position VI, the second attachment segment 2 is arranged in the direction of travel FR at least predominantly in front of the first transfer element 5. Analogously, in the transport position VI, the fourth attachment segment 4 is arranged in the direction of travel FR at least predominantly in front of the second transfer element 6.

The first attachment segment 1 is arranged on the frame device 12 by means of a first transfer element 5. The third attachment segment 3 is mounted mirror-symmetrically on the frame device 12 by means of a second transfer element 6 (FIG. 1). Both transfer elements 5, 6 each have an actuator leg 7 and a segment leg 8 (see FIG. 17). The further mirror-symmetrical structure of the harvesting attachment 10 is described below as an example only for one side thereof.

Preferably, the first attachment segment 1 is pivotably mounted on the first transfer element 5 about a transfer segment pivot axis ÜSA. The first transfer element 5 is pivotably mounted on the frame device 12 about a transfer frame pivot axis ÜRA. The first transfer element 5 is designed in such a way that an end of the first transfer element 5 extending around the transfer frame pivot axis ÜRA extends on the one hand in an auxiliary plane HE, which is at right angles to the transfer frame pivot axis ÜRA (see FIG. 11), whereas an end of the first transfer element 5 extending around the transfer segment pivot axis ÜSA extends, on the other hand, to the auxiliary plane. The segment leg 8 extends between the transfer segment pivot axis ÜSA and the transfer frame pivot axis ÜRA. The second attachment segment 2 is pivotably mounted on the first attachment segment 1 about an intermediate segment pivot axis ZSA.

In order to pivot the second attachment segment 2 about the intermediate segment pivot axis ZSA, the harvesting attachment 10 has a first actuator 22 between the first attachment segment 1 and the second attachment segment 2, which segment is arranged in front of the first transfer element 5 in the direction of travel FR, at least in the working position I of the harvesting attachment 10. In order to pivot the first attachment segment 1 about the transfer segment pivot axis ÜSA, the harvesting attachment 10 has a second actuator 28 between the frame device 12 and a transmission element 24 pivotable about the transfer frame pivot axis ÜRA. A control arm 26 which is pivotably mounted on both sides is arranged between the transmission element 24 and the first attachment segment 1. In order to pivot the first transfer element 5 about the transfer frame pivot axis ÜRA, the harvesting attachment 10 has a third actuator 30 between the frame device 12 and the first transfer element 5. The actuator leg 7 extends between the third actuator 30 and the transfer frame pivot axis ÜRA. The second actuator and the third actuator 30 extend in the working position I of the harvesting attachment 10 above the first attachment segment 1. With respect to the attachment segments 1, 2, 3, 4, the transfer elements 5, 6, the actuators 22, 28, 30, the transmission elements 24, the control arms 26 and the frame device 12, the harvesting attachment 10 is designed to be mirror-symmetrical with respect to the longitudinal center plane LME.

The actuators 22, 28, 30 of the harvesting attachment 10 can be used to carry out a transfer process for transferring the harvesting attachment 10 from the working position I to the transport position VI. During the transfer, the harvesting attachment 10 passes through four intermediate positions II to V between the working position I and the transport position VI, which intermediate positions are illustrated in FIGS. 2 to 5. The effect of the actuators 22, 28, 30 during the transfer process is illustrated by the diagram in FIG. 10.

According to the transfer method according to the invention, a first pivoting A of the second attachment segment 2 relative to the first attachment segment 1 begins (time i), before a further pivoting C, D of the first attachment segment 1 relative to the frame device 12 in a first pivoting direction R1 begins (time iii). The first pivoting A occurs in a second pivoting direction R2, which is opposite to the first pivoting direction R1. In the front view according to FIGS. 1 to 6, the second pivoting direction R2 corresponds to the clockwise direction and the first pivoting direction R1 is counterclockwise.

A second pivoting B of the first attachment segment 1 relative to the frame device 12 in the second pivoting direction R2 begins and ends (times ii, iii) before the further pivoting C, D. The second pivoting B comprises a pivoting of the transfer element 5 relative to the frame device 12 about the transfer frame pivot axis ÜRA. The second pivoting B begins during the first pivoting A (time ii).

The first pivoting A ends (time v) before the further pivoting C, D ends (time vi). The further pivoting C, D comprises a third pivoting C and a fourth pivoting D. During the third pivoting C, the first attachment segment 1 is pivoted relative to the transfer element 5 about the transfer segment pivot axis ÜSA. During the fourth pivoting D, the transfer element 5 is pivoted relative to the frame device 12 about the transfer frame pivot axis ÜRA. The third pivoting C begins and ends (times iii, iv) before or while the fourth pivot D begins (time iv). The second pivoting B and the third pivoting C end before the first pivoting A ends (time v). The fourth pivoting D begins (time iv) before the first pivoting A ends (time v).

FIGS. 7 to 9 are different views of one half of the first harvesting attachment 10 according to FIGS. 1 to 6, wherein the representation partially differs from the representation according to FIGS. 1 to 6 due to a further simplification. FIG. 7 to 9 contain angle information to illustrate the position of the transfer frame pivot axis ÜRA, the transfer segment pivot axis ÜSA and the intermediate segment pivot axis ZSA.

FIGS. 11 to 16 illustrate support wheels 32, 34. A first support wheel 32 is arranged on the second attachment segment 2. The first support wheel 32 is mounted on the second attachment segment in such a way that a rotation axis of the first support wheel 32 is aligned parallel to the support plane AE in the transport position VI. In the working position I, the rotation axis is angled relative to the support plane AE by an angle by which the segment conveying direction SR 2 of the second attachment segment 2 is angled relative to the support plane AE in the transport position VI. The second support wheel 34 is arranged mirror-symmetrically to the first support wheel 32 on the fourth attachment segment 4.

FIG. 13 illustrates the conveying elements 18 of the attachment segments 1, 2, 3, 4 in the working position I of the harvesting attachment 10. Each attachment segment 18 is designed to convey maize plants via an attachment-specific segment conveying path SW1, SW2, SW3, SW4. In the illustrated exemplary embodiment, the segment conveying paths SW1 and SW3 are larger than the segment conveying paths SW2 and SW4. In particular in the case of harvesting attachments 10 according to the invention with larger working widths than those of the illustrated exemplary embodiments, the segment conveying paths SW2 and SW4 are preferably larger than the segment conveying paths SW1 and SW3.

FIG. 12 illustrates two support wheels 32, 34. A first of the support wheels 32 is enclosed by a support wheel device 58. The support wheel device 58 also comprises a support wheel actuator 56, which is variable in length in a wheel actuator direction AR. Furthermore, the support wheel device 58 comprises a wheel control arm element 54 which is pivotably arranged on the second attachment segment 2. A second of the support wheels 34 is mounted on the fourth attachment segment 4 in a similar and mirror-symmetrical manner to the first support wheel 32.

FIGS. 17 and 18 partially show the second harvesting attachment 10 in the working position I in that, for example, no cutting elements and no conveying elements are shown in order to better illustrate the components described below. FIG. 17 is a front view of one half of the second harvesting attachment 10. FIG. 17 illustrates a frame transfer locking device 48 for fixing the second transfer element 6 to the frame device 12 when the harvesting attachment is arranged in the transport position VI. The frame transfer locking device 48 comprises a first locking partner 50 on the frame device 12 and a second locking partner 52 on the second transfer element 6, which are spaced apart from one another in the shown working position I of the harvesting attachment 10 and are engaged with one another in the transport position VI.

In FIG. 17, reference numeral 17a indicates a region of the front view, which is shown enlarged in FIG. 17a. The region shows a frame segment locking device 36 for fixing the third attachment segment 3 to the frame device 12 when the harvesting attachment is arranged in the working position. The frame segment locking device 36 comprises a first locking partner 38 on the frame device 12, a second locking partner 40 on the third attachment segment 3 and a further second locking partner 40 on the first attachment segment 1 (see FIG. 18). The first locking partner 38 is designed as a recess that is open against the transverse direction QR. The second locking partner 40 is designed as a pin extending in the transverse direction QR.

FIG. 18 partially shows the second harvesting attachment 10 in the fourth intermediate position. In FIG. 18, reference numeral 18a indicates a region of the front view, which is shown enlarged in FIG. 18a. The region shows a transfer segment locking device 42 for fixing the fourth attachment segment 4 to the second transfer element 6 when the harvesting attachment is arranged in the transport position VI. The transfer segment locking device 42 comprises a first locking partner 44 on the second transfer element 6 (see also FIG. 17) and a second locking partner 46 on the fourth attachment segment 4. The first locking partner 44 is designed as a hook. The second locking partner 46 is designed as a bolt to be hooked into.

### LIST OF REFERENCE NUMERALS

1 first attachment segment
2 second attachment segment
3 third attachment segment
4 fourth attachment segment
5 first transfer element
6 second transfer element
7 actuator leg
8 segment leg
10 harvesting attachment
12 frame device
14 catchment region
16 cutting element
18 conveying element
20 transfer device
22 first actuator
24 transfer element
28 second actuator
30 third actuator
32 first support wheel
34 second support wheel
36 frame segment locking device
38 first locking partner
40 second locking partner
42 transfer segment locking device
44 first locking partner
46 second locking partner
48 frame transfer locking device
50 first locking partner
52 second locking partner
54 wheel control arm element (better same wording as in description sing
56 support wheel actuator
58 support wheel device
80 harvester vehicle
82 driving element
84 catchment device
86 discharge chute
i start of first pivoting
ii start of second pivoting
iii start of third pivoting/end of second pivoting
iv start of fourth pivoting/end of third pivoting
v end of first pivoting
vi end of fourth pivoting
I working position
II first intermediate position

III second intermediate position
IV third intermediate position
V fourth intermediate position
a first position
b second position
A first pivoting
B second pivoting
C third pivoting
D fourth pivoting
AE support plane
AR wheel actuator direction
FR direction of travel
HE auxiliary plane
LME longitudinal center plane
QR transverse direction
R1 first pivoting direction
R2 second pivoting direction
SR1 segment conveying direction of the first attachment segment
SR2 segment conveying direction of the second attachment segment
SR3 segment conveying direction of the third attachment segment
SR4 segment conveying direction of the fourth attachment segment
SW1 segment conveying path of the first attachment segment
SW2 segment conveying path of the second attachment segment
SW3 segment conveying path of the third attachment segment
SW4 segment conveying path of the fourth attachment segment
ÜRA transfer frame pivot axis
ÜSA transfer segment pivot axis
ZSA intermediate segment pivot axis

1. A harvesting attachment (10) for harvesting crops, comprising
a frame device (12) designed for coupling to a harvesting vehicle (80),
at least four attachment segments (1, 2, 3, 4) designed to receive the crops, which attachment segments (1, 2, 3, 4), in a working position (I) of the harvesting attachment (10), adjoin each other in a first position (a) in a transverse direction (QR) perpendicular to a direction of travel (FR), and
a transfer device (20) which is designed to transfer the harvesting attachment (10) from the working position (I) into a transport position (VI), in which at least a first of the attachment segments (1) is arranged in a second position (b), in which it is arranged pivoted by more than 45° relative to the frame device (12) starting from its first position (a),
characterized in that at least the first attachment segment (1, 3) is movably mounted on at least one first transfer element (5) which is movably mounted on the frame device (12).

2. The harvesting attachment according to claim 1, characterized in that the first attachment segment (1) is mounted on the first transfer element (5) so as to be pivotable about a transfer segment pivot axis (ÜSA) and/or the first transfer element (5) is mounted on the frame device (12) so as to be pivotable about a transfer frame pivot axis (ÜRA).

3. The harvesting attachment according to claim 1, characterized in that the first attachment segment (1) is mounted in such a way that it is arranged between a second of the attachment segments (2) and a third of the attachment segments (3), at least in the working position (I) of the harvesting attachment (10).

4. The harvesting attachment according to claim 1, characterized in that a/the second of the attachment segments (2) is mounted on the first attachment segment (1) so as to be pivotable about an intermediate segment pivot axis (ZSA).

5. The harvesting attachment according to claim 1, characterized in that the transfer device (20) is designed such that the second attachment segment (2) is arranged in front of the first transfer element (5) in the direction of travel (FR) at least in the transport position (VI) of the harvesting attachment (10).

6. The harvesting attachment according to claim 1, characterized in that the transfer device (20) has a first actuator (22) for pivoting the second attachment segment (2) relative to the first attachment segment (1), which is arranged in front of the first transfer element (5) in the direction of travel (FR) at least in the working position (I) of the harvesting attachment (10).

7. The harvesting attachment according to claim 1, characterized in that the transfer device (20) has a transfer arrangement which comprises a second actuator (28) arranged on the frame device (12) for pivoting the first attachment segment (1) relative to the first transfer element (5).

8. The harvesting attachment according to claim 1, characterized in that the transfer arrangement comprises a transmission element (24) which is mounted pivotably about a transmission element pivot axis relative to the first transfer element (5) and/or to the frame device (12), and a control arm element (26) which is arranged at one end on the transmission element (24) and at the other end on the first attachment segment (1).

9. The harvesting attachment according to claim 1, characterized in that the transmission element pivot axis is aligned coaxially with the transmission frame pivot axis (ÜRA).

10. The harvesting attachment according to claim 1, characterized in that the transfer device (20) has a third actuator (30) for pivoting the first transfer element (5) relative to the frame device (12), which actuator is arranged on an actuator leg (7) of the first transfer element (5) extending away from the first attachment segment (1) starting from the transfer frame pivot axis (ÜRA), at least in the working position (I) of the harvesting attachment (10).

11. The harvesting attachment according to claim 1, characterized in that the second actuator (28), the third actuator (30) and/or the transmission element (24) are/is arranged above the first attachment segment (1) at least in the working position (I) of the harvesting attachment (10).

12. The harvesting attachment according to claim 1, characterized in that the first transfer element (5) is designed such that a section of the first transfer element (5) surrounding the transfer frame pivot axis (ÜRA) is arranged on the one hand in an auxiliary plane (HE) perpendicular to the transfer frame pivot axis (ÜRA) and/or to the transfer segment pivot axis (ÜSA), and a section of the first transfer element (5) surrounding the transfer segment pivot axis (ÜSA) is arranged on the other hand in the auxiliary plane (HE).

13. The harvesting attachment according to claim 1, characterized in that the transfer segment pivot axis (ÜSA), the transfer frame pivot axis (ÜRA), the intermediate segment pivot axis (ZSA) and/or the transmission element pivot axis are aligned at least substantially parallel to the direction of travel (FR).

14. The harvesting attachment according to claim 1, characterized by a frame segment locking device (36) for fixing at least the first attachment segment (1) to the frame device (12) and/or to the third attachment segment (3).

15. The harvesting attachment according to claim 1, characterized by a transfer segment locking device (42) for fixing at least the second attachment segment (2) to the first transfer element (5).

16. The harvesting attachment according to claim 1, characterized by a frame transfer locking device (48) for fixing at least the first transfer element (5) to the frame device (12).

17. The harvesting attachment according to claim 1, characterized in that each of the attachment segments (1, 2, 3, 4) has at least one cutting element (16) circulating during operation for cutting the crops and at least one conveying element (18) circulating during operation for conveying the crops in a segment conveying direction (SR1, SR2, SR3, SR4).

18. The harvesting attachment according to claim 1, characterized in that each attachment segment (1, 2, 3, 4) has a conveying element (18) de-signed as a conveying chain and two rotatably mounted deflection elements around which the conveying element (18) circulates during operation.

19. A harvesting system comprising the harvesting vehicle (80) having a carriage with a plurality of driving elements (82) adjacent to a support plane (AE) and a harvesting attachment (10) according to claim 1, which is coupled to the harvesting vehicle (80) by means of the frame device (12).

20. The harvesting system according to claim 19, wherein the harvesting vehicle (80) has a catchment device (84) which, during operation, draws in the crops from a catchment region (14) of the harvesting attachment at least partially against the direction of travel (FR).

21. The harvesting system according to claim 19, wherein the harvesting vehicle (80) is designed as a forage harvester with a chopping unit connected to the catchment device (84) and a discharge chute (86).
